(19) United States
(12) Patent Application Publication
(10) Pub. No.: US 2019/0153775 A1
(43) Pub. Date: May 23, 2019

(54) Ward for improving health

(71) Applicant: Tianze HAN, Beijing (CN)

(72) Inventor: Tianze HAN, Beijing (CN)

(21) Appl. No.: 15/989,456

(22) Filed: May 25, 2018

(30) Foreign Application Priority Data
Nov. 17, 2017 (CN) 201711144897.5

(51) Int. Cl. E06B 9/24; E06B 5/00

(52) U.S. Cl. CPC E06B 9/24; C03C 4/0085; E06B 2009/2417; E06B 5/00

(57) ABSTRACT

The invention “a ward for improving health” belongs to the ward field. The ward includes glass window, characterized in that all or part of the glass window has glass structure which can be penetrated through by UVB, and the glass structure is a controllable glass structure, the controllable glass structure is a glass structure, of which UVB transmission amount is controllable. It's verified that, the ward of the invention can make patients get sufficient UVB exposure so as to meet the needs of synthesis of vitamin D in organism in the limited time, compared to ordinary ward and regular outdoor sunlight, the effect of vitamin D synthesis is better, and patients don't need to walk, which is very convenient for bedridden or disabled patients.

### TECHNICAL FIELD

The present disclosure refers to a ward, especially a ward for improving health.

### BACKGROUND

Vitamin D is an indispensable element in the human body, and vitamin D basically has the following function: (1) improving the absorption of calcium and phosphorus in the organism, to make levels of the plasma calcium and plasma phosphorus reach saturation degree; (2) pomoting growth and bone calcification, and promoting dental healthiness; (3) increasing absorption of phosphorus through the intestinal wall and increase reabsorption of phosphorus through the renal tubule; (4) maintaining normal level of citrate in blood; (5) preventing loss of amino acids through kidneys; (6) Vitamin D also has a certain effect of regulating neuromuscular function and enhancing immunologic mechanism.

Vitamin D is mainly derived from a substance called 7-dehydrocholesterol in the skin. After exposure to ultraviolet light in the sun, it can produce vitamin D3, which can increase the absorption of calcium in the intestinal tract. In the intestinal tract, Vitamin D3 is absorbed into the blood in some way, and isconverted into another active form which plays a role in the target organs. Its effect to prompt calcium absorption is mainly in two organs: the small intestine and the kidney. In the small intestine, the active form of vitamin D induces a protein that can bind calcium. This protein binds calcium ions and transports calcium into the blood as a carrier. Meanwhile, this protein can also increase the permeability of the small intestinal mucosa to calcium, and transport the calcium into the blood actively through the mucosa. In the kidney, the active form of vitamin D plays a direct role on the kidney, promoting the reabsorption of calcium and phosphorus by the kidney, thereby to reduce the loss of calcium and phosphorus. There is evidence that people who live in high latitude areas (where the sunlight is insufficient) more easily suffer and die from ovarian cancer, colon cancer or other cancers.

Intake of vitamin D by eating food is an important aspect. However, 90% vitamin D is synthesized by the skin itself under sunlight. The amount of vitamin D that is really got from food is only about 10%, so the safest, most effective, most economical way to replenish vitamin D is to bask in the sun.

The production of vitamin D is closely related to the ultraviolet rays (UV) irradiation in sunlight. More than 90% of vitamin D which is needed in the human body is derived from solar radiation to the skin. The amount and intensity of ultraviolet rays in sunlight have an important effect on the physiological function of sunlight in the skin. The current lifestyle limits people's organism from exposure to UV radiation, which leads to vitamin D deficiency. However, too much UV exposure will cause skin tumors. Therefore, moderate solar radiation has a significant importance to human health. Ultraviolet rays consist of four wave bands: UVA, UVB, UVC and UVD, and which has physiological effect on the human body is the second band UVB.

Currently, the daily dose of vitamin D needs to be increased to 800-1000 international units. However, it is impossible for people to get such a large amount of vitamin D from the diet.

Patients in the ward, especially those who cannot move freely or are under long-term bed for treatment, are unable to get outdoors for supplying vitamin D due to failing to move. Even if it's available to open windows to allow sunlight to enter the ward, it's still unable to replenish adequate level of vitamin D, since it is necessary to close the window during certain times, such as during the cold winter heating period, or when it rains.

According to International Standardization Organization ISO 9050-1990, the glass UV transmittance should not exceed 20%, and this 20% of UV, is mainly UVA. Ordinary glass has partial blocking effect on UVA, which can effectively block the majority of UVB. More specifically, ordinary glass blocks more than 90% of UV whose wave length is less than 300 nm, but allows more than 90% of UV whose wavelength is greater than 350 nm. For UVA, whose wavelength is between 350-300 nm, the blocking effect of glass is between 10˜90%.

UVA wave band, with wavelength of 320˜400 nm, is also called as long-wave black spot effect ultraviolet. It has a strong penetrating power that penetrates most of the transparent glass and plastic. UVB wave band, with wavelength of 275˜320 nm, is also called as medium-wave erythema effect ultraviolet. It has a medium penetration, and part of it with shorter wavelength is absorbed by transparent glass. Most of the UVB in sunlight is absorbed by ozonosphere; only less than 2% can reach earth surface, and is particularly strong in summer and in the afternoon. UVC wave band, with wavelength of 200˜275 nm, is also known as short wave sterilization ultraviolet, whose penetration is weakest and cannot penetrate most of the transparent glass and plastic. UVD band, with wavelength of 100˜200 nm, is also known as vacuum ultraviolet, which absorbed by ozonosphere.

Because ordinary windows also block UVB, people have to go out and bask in the sunshine to supplement vitamin D. But patients in ward, especially those who cannot move freely or in long-term bed for treatment, and those who must be in the special ward and cannot move, cannot normally get sufficient vitamin D, which affects their health.

### SUMMARY

In order to solves the technical problem that the existing ward cannot get enough vitamin D for patients and affects the health, The present disclosure provides a ward for improving health, that allows the patient to obtain adequate vitamin D in the ward.

The technical solution of the present invention is as follows: A ward for improving health, comprising a glass window, characterized in that, whole or part of the glass window has glass structure which can be penetrated through by UVB, and the glass structure is a controllable glass structure, the controllable glass structure is a glass structure, of which UVB transmission amount is controllable. The controllable glass structure refers to the glass structure of the glass window acting as the structure of the ward that UVB can penetrate through only in a period of time. The glass structure refers to a flat glass adhered by a membrane or coating which can be penetrated through by UVB.

The membrane or coating blocks UVA and UVC.

The UVB transmissivity is above 80%; or above 60%; or above 50%; or no less than 30%.

The glass structure refers to no or few ultraviolet rays absorption material is added in the glass preparation.

The ultraviolet rays absorption material is selected from the group consisting of Fe₂O₃, CeO₂, TᵢO₂ or other ultraviolet rays absorption material.

The glass structure refers to UVA and/or UVC absorption material is added in the glass preparation.

The period of time refers to 0.2 hour to several hours in the daytime.

The controllable glass structure comprises the glass structure and a movable structure on the glass window which can move up to the glass structure to block UVB penetrating through; or comprises the glass structure and a covering part which covers the glass window, the covering parts includes curtain.

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art. Many of the techniques and procedures described or referenced herein are well understood and commonly employed using conventional methodology by those skilled in the art.

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art. Many of the techniques and procedures described or referenced herein are well understood and commonly employed using conventional methodology by those skilled in the art.

All headings are for the convenience of the reader and should not be used to limit the meaning of the text that follows the heading, unless so specified.

As used herein and in the appended claims, the singular forms “a,” “an,” and “the” include plural referents unless the context clearly dictates otherwise. For example, “a” or “an” means “at least one” or “one or more.”

The invention provides a ward for improving health, comprising a glass window, characterized in that, whole or part of the glass window has glass structure which can be penetrated through by UVB, and the glass structure is a controllable glass structure, the controllable glass structure is a glass structure, of which UVB transmission amount is controllable. Whether for patients or the healthy population, in the wards with the glass structure provided by this invention, they can receive sufficient UVB irradiation without stay outdoors, so as to enable sufficient vitamin D generated internally to maintain needs of organism. Especially for those patients who are not convenient for move or need long-time bed, it is necessary to stay in the wards of this invention, which can satisfy organism needfor sufficient vitamin D, without going out to bask in the sunshine.

Further, the controllable glass structure refers to the glass structure of the glass window acting as the structure of the ward that UVB can penetrate through only in a period of time. This structure makes UVB transmission amount of the ward disclosed in this invention controllable, thus UVB penetrating into the ward will be adjusted to meet irradiation requirements of different patients according to needs of the patients.

In some embodiments, the glass structure refers to a flat glass adhered by a membrane or coating which can be penetrated through by UVB. There are many ways to achieve UVB-permeable glass structures, and sticking an UVB-permeable membrane or coating on ordinary glass is one of the ways.

In further example of the above embodiments, the membrane or coating blocks UVA and UVC. UVA and UVC have no assist and benefits for producing vitamin D in humans, so they need to be filtered out.

Preferably, the UVB transmissivity is above 80%; or above 60%; or above 50%; or no less than 30%. Its shown by the experimental results that, UVB penetrated through the glass with above transmissivity to organism, can enable organism to synthesize vitamin D within a reasonable time and maintain vitamin D in the normal level, which achieves remarkable effect compared with a ward with conventional glass or regular sunshine bathing.

In the other embodiments, the glass structure refers to no or few ultraviolet rays absorption material is added in the glass preparation.

Specifically, the ultraviolet rays absorption material is selected from the group consisting of Fe₂O₃, CeO₂, TᵢO₂ or other ultraviolet rays absorption materials.

In the other embodiments, the glass structure refers to UVA and/or UVC absorption material is added in the glass preparation. Specifically, UVA absorption material include: “1,2-hydroxy-4-methoxybenzophenone”, which is benzophenone containing two ortho-hydroxies, with strong capacity of absorbing ultraviolet light with wavelength 330-370 nm(equivalent to UVA); and/or, “Tian Lai Shi (annotation) M (TinosorbTMM)”, it has dual function of absorbing and scattering UVA-band ultraviolet rays, and has extremely high photostability; and/or “2,4-dihydroxy-benzophenone”, it is also one kind of UVA absorbent commonly used in this field;

UVC absorption material include: “0.1% of Moringa leifera Oil”, which can absorb UVC band rays (see “Study on Anti-ultroviolet Properties of Moringa leifera Oil”), etc.

Because of the short wavelength of UVC, most wave bands of UVC can be blocked by transparent plastic and ordinary glass, therefore, the glass structure can be a common glass coating with one or some of above UVA absorption materials.

Its well-known in the art of glass, there are coated and uncoated 5 mm thick glass, including: ordinary uncoated white glass, uncoated blue glass and uncoated green glass, which can be penetrate by most of the ultraviolet (UVA+UVB), as well as coated blue glass and coated green glass, through which lower limit of wavelength of ultraviolet radiation penetrating is about 330 nm. In other words, most kinds of glass can block a part of UVA, and among them, the coated green glass have the strongest UVA barrier effect, therefore, the glass structure in this invention can also be green glass further coated with UVA absorption material and UVB absorption material.

Alternatively, an example that a specially glass that blocks full band ultraviolet rays is coated with UVB transmission material can be directly applied ; the UVB transmission material includes: UVB phosphor powder.

In addition, “high temperature melting method”, a method commonly used in the art of glass, can also be used to synthesis luminescent borate glass with rare earth ion Sm³⁺ mixed (see “Characterization for Multi-channel Transition And Fluorescence Property of Trivalent Rare Earth Ion in Borate Glasses”), or using melt quenching technology to prepare calcium borate glass mixing Sm³⁺, of which the components is: 30CaO-60B₂O₃-10AgNO₃-xSm₂O₃(x=0.05,0.25,0.5,1,3,5 (mole fraction))(the preparation process see “Preparation and Luminescence Properties of Sm³⁺ doped Calcium Borate Glasses Containing Silver”), both of them can penetrate UVB rays of sunlight primely, and their UVB transmissivity can be adjusted by adjusting the proportion of Sm³⁺ ions during preparation.

In specific embodiments, the period of time refers to 0.2 hour to several hours in the daytime. Since UVB transmissivity is controllable, time of light transmission of ward every day can be controlled according to different ward glasses with different transmissivity, based on UVB total amount needs of different patients, so as to control total amount of UVB rays. The controllable total amount of UVB not only satisfy need of patients' daily irradiation to synthesize vitamin D in vivo, but also protect patients' skin health from excessive exposure under UVB rays.

More specifically, the controllable glass structure comprises the glass structure and a movable structure on the glass window which can move up to the glass structure to block UVB penetrating through; or comprises the glass structure and a covering part which covers the glass window, the covering parts includes curtain. In addition to curtain, other blocking sunshine structures are also available, such as shutters, etc. The existing manual, automatic control, or intelligent control means can be combined, to further improve the convenience of operating glass window of the ward of the invention.

Technical effects: Because all or part of window of ward is set as the glass structure which can be penetrated through by UVB, ultraviolet band which has a physiological effect to the skin can penetrate into the ward, and skin of patients in the ward can automatically synthesis vitamin D, so as to promote organism health. At the same time, because the glass structure is the structure whose UVB transmission amount is controllable, this will ensure that the patient's skin will not absorb too much UVB, so as to prevent the patient's skin from injury. Meanwhile, if s verified that, the ward of the invention can make patients get sufficient UVB irradiation so as to meet the needs of synthesizing vitamin D in organism in a limited time; compared to the conventional means like ordinary ward and regular outdoor sunlight, the effect of vitamin D synthesis is better, and patients don't need to walk, which is very convenient for bedridden or disabled patients.

### BRIEF DESCRIPTION OF THE DRAWINGS

FIG. 1 illustrates the controllable glass structure and detection structure of the ward provided by an example of the invention; The reference signs in FIG. 1 are shown as below: 1—the controllable glass structure, 11—the glass structure, 12—the movable structure; 2—the detection structure, 21—the detection section, 22—the control section.

### EMBODIMENTS

The attached drawings and specific embodiments are combined to describe the technical solution of this invention more specifically and detailedly as follows. If s shall be declared that, any of the following examples are just exemplary, or as illustration not exhaustion of a solution of the present invention; and the scope of protection of invention is not limited by content of any of the following examples. Unless otherwise specified. The consumables and accessories used in the following embodiments are available for purchase.

The present invention provides a ward for improving health. In all examples of the present invention, the ward has the following common features: the ward comprises glass window, all or part of the glass window has a glass structure which can be penetrated through by UVB, and the glass structure is a controllable glass structure, the controllable glass structure is glass structure, of which UVB transmission amount is controllable.

In further examples, the controllable glass structure refers to the glass structure of the glass windows acting as the structure of the ward that UVB can penetrate through only in a period of time.

In some examples, the glass structure refers to a flat glass adhered by a membrane or coating which can be penetrated through by UVB.

In specific examples, the membrane or coating blocks UVA and UVC.

In more specific embodiments, the UVB transmissivity is above 80%; or above 60%; or above 50%; or no less than 30%. The present invention is not limited to the transmissivity of above specific numerical values, for example, glasses with other UVB transmissivity can be prepared for being installed in the ward, as shown in table 1 in the following experimental example.

In some other examples, the glass structure refers to no or few ultraviolet rays absorption material is added in the glass preparation.

In the preferred example, the ultraviolet rays absorption material is selected from the group consisting of Fe₂O₃, CeO₂, TᵢO₂ or other common ultraviolet rays absorption materials.

In further preferred examples, the glass structure refers to UVA and/or UVC absorption material is added in the glass preparation, that is to say, no or few ordinary ultraviolet absorption materials are added in the glass structure, but UV absorption materials that specifically absorb UVA and/or UVC are added.

Specifically, UVA absorption material include: “1,2-hydroxy-4-methoxybenzophenone”, which is benzophenone containing two ortho-hydroxies, with strong capacity of absorbing ultraviolet light with wavelength 330-370 nm(equivalent to UVA); and/or, “Tian Lai Shi (annotation) M (TinosorbTMM)”, it has dual function of absorbing and scattering UVA-band ultraviolet rays, and has extremely high photostability; and/or “2,4-dihydroxy-benzophenone”, it is also one kind of UVA absorbent commonly used in this field; and so on;

UVC absorption material include: “0.1% of Moringa leifera Oil”, which can absorb UVC band rays (see “Study on Anti-ultroviolet Properties of Moringa leifera Oil”), etc.

Because of the short wavelength of UVC, most wave bands of UVC can be blocked by transparent plastic and ordinary glass, therefore, the glass structure can be a common glass coating with one or some of above UVA absorption materials.

It's well known in the art of glass, there are coated and uncoated 5 mm thick glass, including: ordinary uncoated white glass, uncoated blue glass and uncoated green glass, which can be penetrate by most of the ultraviolet (UVA+UVB), as well as coated blue glass and coated green glass, through which lower limit of wavelength of ultraviolet radiation penetrating is about 330 nm. In other words, most kinds of glass can block a part of UVA, and among them, the coated green glass have the strongest UVA barrier effect, therefore, the glass structure in this invention can also be green glass further coated with UVA absorption material and UVB absorption material.

Alternatively, an example that a specially glass that blocks full band ultraviolet rays coated with UVB transmission material can be directly applied; the UVB transmission material include: Ce³⁺ and/or Sm³⁺, or membrane or coating containing these two ions; Or other conventional UVB transmission materials or materials that can improve the transmission capability of glass to UVB in this field, like UVB phosphor powder.

Said UVB phosphor powder refers to calcium orthophosphate phosphor powder ((Ca, Zn)₃(PO₄)₂:Tl), or, UVB phosphor powder recorded in Chinese Patent No. 201510698095.3.

In addition, “high temperature melting method”, a method commonly used in the art of glass, can also be used to synthesis luminescent borate glass with rare earth ion Sm³⁺ mixed (see “Characterization for Multi-channel Transition And Fluorescence Property of Trivalent Rare Earth Ion in Borate Glasses”), or using melt quenching technology to prepare calcium borate glass mixing Sm³⁺, of which the components is: 30CaO-60B₂O₃-10AgNO₃₋ₓSm₂O₃(x=0.05,0.25,0.5,1,3,5 (mole fraction)) (the preparation process see “Preparation and Luminescence Properties of Sm³⁺ doped Calcium Borate Glasses Containing Silver”), both of them can penetrate UVB rays of sunlight primely, and their UVB transmissivity can be adjusted by adjusting the proportion of Sm³⁺ ions during preparation.

Various conventional materials, conventional methods used in above specific examples are exemplary, rather than exhaustive. Based on this disclosure, a person skilled in the art can find the other regular materials or methods which play the same role in preparing a glass that only let UVB penetrating through, but block UVA and UVC.

In the specific embodiments, the period of time refers to 0.2 hour to several hours in the daytime.

In more specific embodiments, the controllable glass structure comprises the glass structure and a movable structure on the glass window which can move up to the glass structure to block UVB penetrating through; or comprises the glass structure and a covering part which covers the glass window, the covering parts includes curtain, In addition to curtain, other blocking sunshine structures are also available, such as shutters, etc. The existing manual, automatic control, or intelligent control means can be combined, to further improve the convenience of operating glass window of the invention .

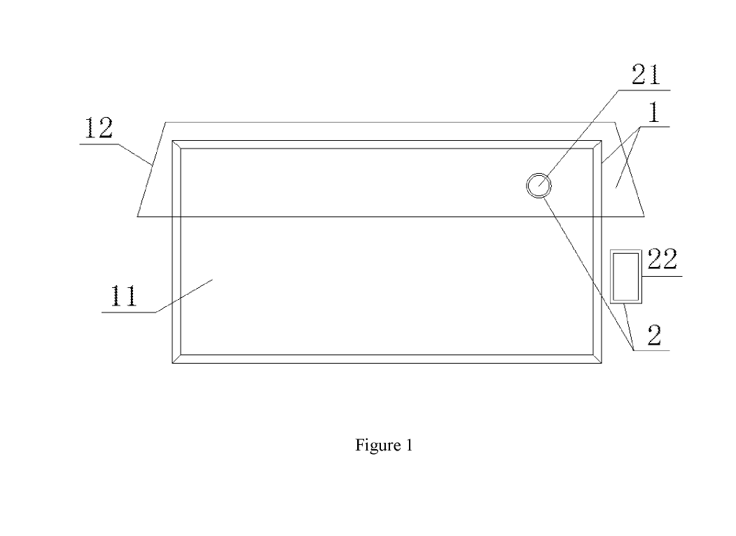

Further, the ward also includes a detection structure 2, as shown in FIG. 1, and the detection structure 2 is set inside of the wall of the ward or inside the controllable glass structure 1, the detection structure 2 comprise a detection part 21 which detects the UVB transmission amount, and a control part 22 which is connected to the detection part 21, the control part 22 control the movable structure 12 or the covering part of the controllable glass structure 1 to cover the glass structure 11 according to the UVB transmission amount detected by the detection part 21.

Specifically, the control part is a intellisense automatic control unit (not shown in the figure) which is built-in inside the detection structure; it can also be a form of an external remote control (not shown in the figure); the detection part detects the UVB transmission amount, then transmits the data of the UVB transmission amount to intellisense automatic control unit; as to intellisense automatic control unit, based on its internally-preset recognition program, when the UVB transmission amount received is higher than a certain value, it will be triggered to control the movable structure to cover the glass structure, in order to block the sunlight to enter the room.

The form of an external remote controller refers to, the detection part is equipped with a built-in control chip inside and an intelligent display screen outside, and the control chip is connected to the external remote controller wirelessly or through wire. The external remote controller is connected to the movable structure wirelessly or through wire at the same time; the detection part detects the UVB transmission amount and transmit the data of the UVB transmission amount to said intelligent display screen, people (patients/subjects/staff) in the ward read the data displayed on intelligent display screen. If people in the ward think the UVB transmission amount has reached the expectant, they can control the movable structure to cover the glass structure by using said external remote controller directly, in order to block sunshine entering the ward.

Experiment example: Vitamin D generation effect contrast between the ward disclosed by the present invention, the general ward and the sunbath outside.

It's well-known in the medical field, the concentration of 25-hydroxy vitamin D (25(OH)D) in the serum can represent the level of vitamin D in organism; and, levels of 25(OH)D in vivo are classified as follows:

Vitamin D insufficiency: 21-29 ng/mL (52.5-72.5 mmol/L)

Vitamin D deficiency: <20 ng/mL (<50 mmol/L)

500 subjects were selected in clinical trials and divided into 10 groups, and there were 50 people in each group. All subjects received test, and the test lasted for 7 days. First 8 groups are respectively arranged in the ward according any one of above example disclosed in this invention (not went out of the ward during the test), the 9^{th} group is arranged in the conventional ward (not went out of the ward during the test), the 10^{th} group is arranged to walk around in outdoors and sunbath for 2 hours between 8 to 11 o'clock in the morning every day, and in other times they stayed in the conventional ward without go out; Subjects in each group were in a healthy and stable condition before the test, without any diseases related to vitamin D metabolism. They were consistent in their daily diet and did not take any vitamin supplements during the test.

After the test, the conventional method of clinical detection field was used to measure concentrations of 25-hydroxy vitamin D (25 (OH) D) in serum of all subjects in each group, and the average vitamin D level of subjects of each group was counted. The results are shown in table 1 below.

TABLE 1

| | | | Duration of | the average |
|---|---|---|---|---|
| | | | sun exposure | vitamin D level |
| Group | sun exposure | UVB | (unit: | of subjects |
| NO. | types | transmissivity | hour/day) | (unit: ng/mL) |
| 1 | Ward | 90% | 0.2 | 59 |
| 2 | disclosed in | 80% | 0.5 | 80 |
| 3 | invention | 70% | 0.7 | 66 |
| 4 | | 60% | 0.8 | 60 |
| 5 | | 55% | 0.6 | 55 |
| 6 | | 50% | 0.9 | 58 |
| 7 | | 45% | 1 | 62 |
| 8 | | 30% | 2 | 75 |
| 9 | the | — | Above | 25 |
| | conventional | | 3 hours | |
| | ward | | | |
| 10 | Sunbath | — | 2 hours | 80 |
| | outside | | | |

UVB transmissivity listed in above table 1 corresponding to group No. 1 to 8 refers to the UVB transmissivity of the glass window of the ward in which the subjects of the group were stayed. The column of “Duration of sun exposure”, refers to the duration time that sunlight penetrating through the glass window of the present invention ward and/or the conventional ward, for example, if the window is with curtain, it means the duration time that curtain was open (curtain was closed in the other time, and sunlight was blocked to enter indoor). Subjects in the wards could shed excess clothing, to expose more skin to accept the sunshine penetrated in room. In the above table, it can be seen that, the duration of sun exposure hours in the ward of the present invention is less than that of the conventional wards and sunbath outside as a whole, and obviously, the ward of the present invention have a good effect on providing UVB, at the same time, the duration of sun exposure in the ward of this invention is shorter, high efficient, to ensure the patients/subjects in the wards disclosed in this invention ward to receive sufficient UVB to produce sufficient vitamin D in organism to maintain organism health without going outside.

1. A ward for improving health, comprising a glass window, wherein whole or part of the glass window has glass structure which can be penetrated through by UVB, and the glass structure is a controllable glass structure, the controllable glass structure is a glass structure, of which UVB transmission amount is controllable.

2. The ward for improving health according to claim 1, wherein the controllable glass structure refers to the glass structure of the glass window acting as the structure of the ward that UVB can penetrate through only in a period of time.

3. The ward for improving health according to claim 1, wherein the glass structure refers to a flat glass adhered by a membrane or coating which can be penetrated through by UVB.

4. The ward for improving health according to claim 3, wherein the membrane or coating blocks UVA and UVC.

5. The ward for improving health according to claim 4, wherein the UVB transmissivity is above 80%; or above 60%; or above 50%; or no less than 30%.

6. The ward for improving health according to claim 1, wherein the glass structure refers to no or few ultraviolet rays absorption material is added in the glass preparation.

7. The ward for improving health according to claim 6, wherein the ultraviolet rays absorption material is selected from the group consisting of Fe₂O₃, CeO₂, TiO₂ or other ultraviolet rays absorption materials.

8. The ward for improving health according to claim 1, wherein the glass structure refers to UVA and/or UVC absorption material is added in the glass preparation.

9. The ward for improving health according to claim 2, wherein the period of time refers to 0.2 hour to several hours in the daytime.

10. The ward for improving health according to claim 9, wherein the controllable glass structure comprises the glass structure and a movable structure on the glass window which can move up to the glass structure to block UVB penetrating through; or comprises the glass structure and a covering part which covers the glass window, the covering parts includes curtain;
preferably, the ward also includes a detection structure, and the detection structure is set inside the wall of the ward or inside the controllable glass structure; the detection structure comprises a detection part which detects the UVB transmission amount, and a control part which is connected with the detection part, the control part can control the movable structure or the covering part of the controllable glass structure to cover the glass structure according to the UVB transmission amount detected by the detection part.

11. The ward for improving health according to claim 2, wherein the glass structure refers to a flat glass adhered by a membrane or coating which can be penetrated through by UVB.
